(19) United States
(12) Patent Application Publication
(10) Pub. No.: US 2012/0160389 A1
(43) Pub. Date: Jun. 28, 2012

(54) PNEUMATIC TIRE AND METHOD OF MANUFACTURING PNEUMATIC TIRE

(76) Inventors: Atsushi Tanno, Hiratsuka-shi (JP); Yuji Kodama, Hiratsuka-shi (JP); Yuji Sato, Hiratsuka-shi (JP); Jun Matsuda, Hiratsuka-shi (JP); Noboru Takada, Hiratsuka-shi (JP); Susumu Imamiya, Hiratsuka-shi (JP)

(21) Appl. No.: 13/335,489

(22) Filed: Dec. 22, 2011

(30) Foreign Application Priority Data
Dec. 28, 2010 (JP) 2010-294206
Nov. 21, 2011 (JP) 2011-254254

(51) Int. Cl. B60C 9/02; B23K 31/02

(52) U.S. Cl. 152/527; 228/101; 228/155

(57) ABSTRACT

A pneumatic tire including a cylindrical annular structure, a rubber layer that will become a tread portion provided along a circumferential direction of the annular structure, on an outer side of the annular structure, and a carcass portion including fibers covered by rubber, provided on both sides in a direction parallel to a center axis (Y-axis) of a cylindrical structure including the annular structure and the rubber layer.

### PRIORITY CLAIM

Priority is claimed to Japan Patent Application Serial No. 2010-294206 filed on Dec. 28, 2010, and Japan Patent Application Serial No. 2011-254254 filed on Nov. 21, 2011.

### BACKGROUND

1. Technical Field

The present technology relates to a pneumatic tire.

2. Related Art

Reducing the rolling resistance of a pneumatic tire is useful for improving the fuel consumption of a vehicle. Techniques exist for reducing the rolling resistance of a tire such as, for example, using a silica-compounded rubber for the tread.

While the technique for reducing the rolling resistance of pneumatic tires described in Recent Technical Trends in Tires, Akimasa DOI, Journal of the Society of Rubber Industry, September 1998, Vol. 71, p. 588-594 provides an improvement to the material, it is also possible to reduce the rolling resistance by modifying the structure of the pneumatic tire.

### SUMMARY

The present technology provides a structure whereby the rolling resistance of a pneumatic tire is reduced. A pneumatic tire includes an annular structure that is a cylindrical and metal structure, having a tensile strength of not less than 450 N/m² and not more than 2,500 N/m²; a rubber layer, which will become a tread portion, provided along a circumferential direction of the annular structure on an outer side of the annular structure; and a carcass portion including fibers covered with rubber, provided on at least both sides in a direction parallel to a center axis of the cylindrical structure including the annular structure and the rubber layer.

In a meridian cross-section of the structure, an outer side of the rubber layer and the outer side of the annular structure preferably have the same form.

The annular structure is preferably formed by abutting edges of band-like steel plates and welding.

A thickness at a region of the annular structure, except at a welded portion, is preferably not less than 0.1 mm and not more than 0.8 mm; and a thickness of a portion of the welded portion that is greater than the thickness of surroundings of the welded portion is preferably not more than 1.3 times the thickness of the surroundings.

The annular structure is preferably obtained by joining edges of both sides in a longitudinal direction of a plate material by welding, the plate material having a substantially rectangular form when viewed planarly, and having protrusions that protrude outward in a direction parallel to a lateral direction on the sides of both edges in the longitudinal direction on both edges in the lateral direction; and, thereafter, removing the protrusions.

The annular structure is preferably a metal.

The annular structure is preferably stainless steel.

The outer side of the rubber layer and the outer side of the annular structure, except a groove portion of the rubber layer, are preferably parallel to the center axis.

The annular structure is preferably disposed farther outward in a radial direction of the structure than the carcass portion.

A dimension in the direction parallel to the center axis of the annular structure is preferably not less than 50% and not more than 95% of a total width in the direction parallel to the center axis of the pneumatic tire.

A distance between the outer side of the annular structure and the outer side of the rubber layer is preferably not less than 3 mm and not more than 20 mm.

A method of manufacturing a pneumatic tire is provided, wherein the pneumatic tire includes a rubber layer that will become a tread portion, provided on an outer side of a cylindrical and metal annular structure. The method includes the steps of obtaining a plate material having a rectangular form when viewed planarly, and having protrusions that protrude outward in a direction parallel to a lateral direction on sides of both edges of a metal plate in a longitudinal direction on both edges in the lateral direction; joining both edges in the longitudinal direction of the plate material by welding; and removing the protrusions, thereby obtaining the annular structure.

After joining the plate material by welding, preferably the joined cylindrical plate material is subjected to heat-treating and/or the joined cylindrical plate material is subjected to drawing in an axial direction.

The present technology can provide a structure whereby the rolling resistance of a pneumatic tire is reduced.

### BRIEF DESCRIPTION OF THE DRAWINGS

FIG. 1 is a meridian cross-sectional view of a tire according to an embodiment.

FIG. 2-1 is a perspective view of an annular structure included in the tire according to the embodiment.

FIG. 2-2 is a perspective view of a modified example of the annular structure included in the tire according to the embodiment.

FIG. 3 is an enlarged view of a carcass portion included in the tire according to the embodiment.

FIG. 4 is a meridian cross-sectional view of the annular structure and a rubber layer.

FIG. 5 is a flowchart showing steps of a method for manufacturing the annular structure included in the tire according to the embodiment.

FIG. 6-1 is an explanatory drawing illustrating a step of the method for manufacturing the annular structure included in the tire according to the embodiment.

FIG. 6-2 is an explanatory drawing illustrating a step of the method for manufacturing the annular structure included in the tire according to the embodiment.

FIG. 6-3 is an explanatory drawing illustrating a step of the method for manufacturing the annular structure included in the tire according to the embodiment.

FIG. 6-4 is a cross-sectional view illustrating a thickness of a welded portion.

### DETAILED DESCRIPTION

A form of the present technology (embodiment) is described below in detail while referring to the drawings. However, the present technology is not limited to the description given in the embodiment. Additionally, the constituents described below include those constituents that could be easily conceived by a person skilled in the art, and constituents that are essentially identical to those described herein. Furthermore, it is possible to combine the constituents described below as desired.

When eccentric deformation is increased to a limit thereof in order to reduce the rolling resistance of a pneumatic tire (hereinafter referred to as “tire” as necessary), ground contact area between the tire and a road surface decreases and ground contact pressure increases. As a result, viscoelastic energy loss, caused by deformations of a tread portion, increases, leading to an increase in rolling resistance. The present inventors focused on this point and attempted to reduce rolling resistance and enhance steering stability by ensuring the ground contact area between the tire and the road surface and maintaining eccentric deformation. Eccentric deformation is a single-dimensional mode of deformation in which a tread ring (crown region) of the tire shifts vertically while the round form of the tire is maintained. In order to ensure ground contact area between the tire and the road surface and maintain eccentric deformation, the tire according to this embodiment uses, for example, a structure including a cylindrical annular structure that is manufactured from a thin plate of a metal. A rubber layer is provided along a circumferential direction on an outer side of the annular structure. This rubber layer constitutes the tread portion of the tire.

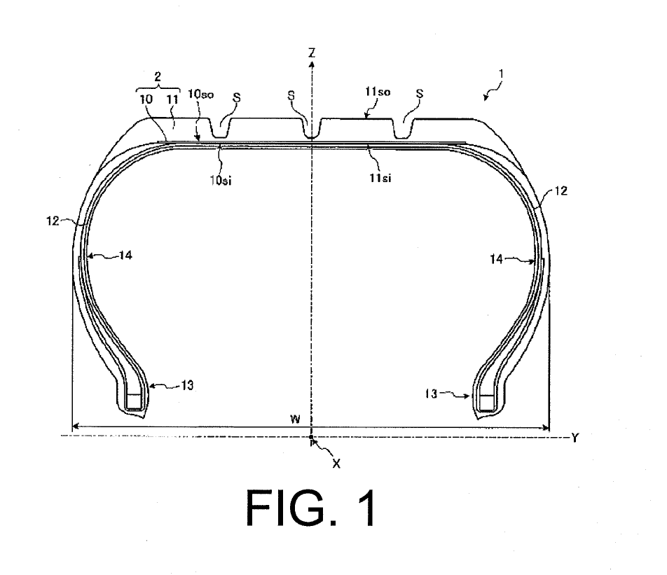

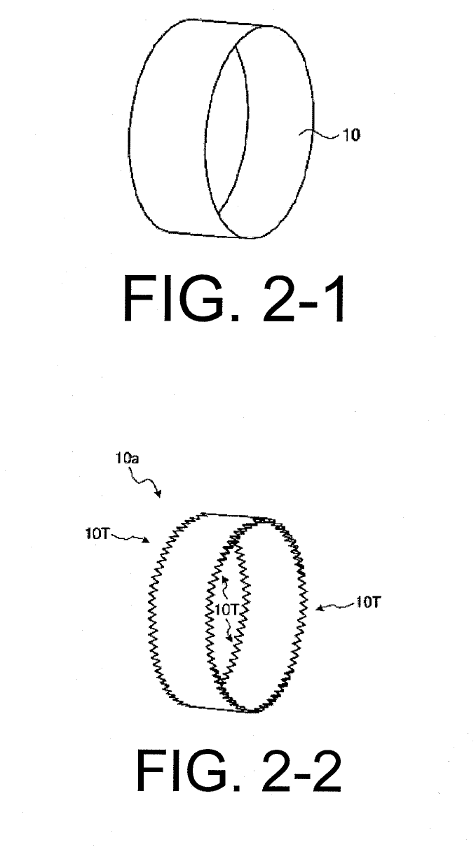

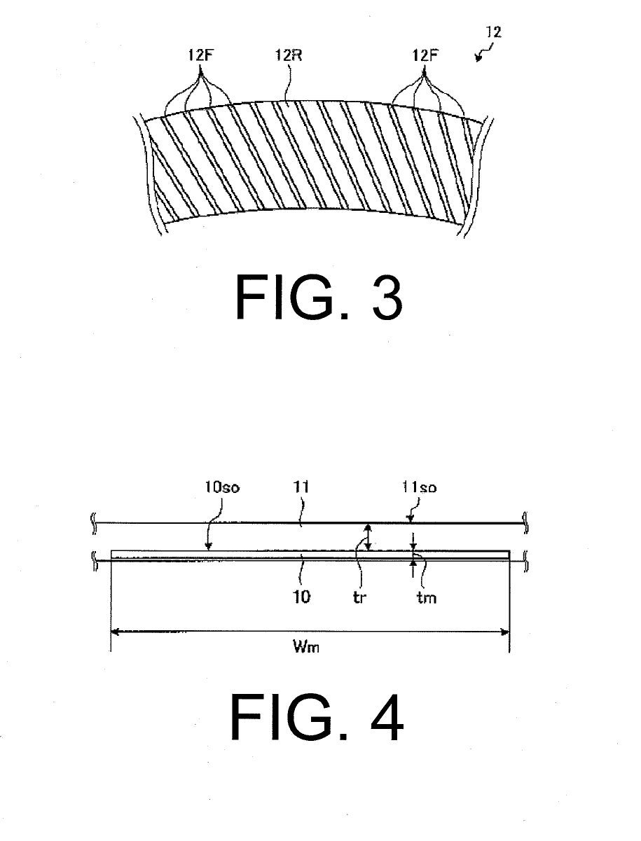

FIG. 1 is a meridian cross-sectional view of a tire according to an embodiment. FIG. 2-1 is a perspective view of an annular structure included in the tire according to the embodiment. FIG. 2-2 is a perspective view of a modified example of the annular structure included in the tire according to the embodiment. FIG. 3 is an enlarged view of a carcass portion included in the tire according to the embodiment. A tire 1 is an annular structure. An axis that passes through a center of the annular structure is a center axis (Y-axis) of the tire 1. When in use, an interior of the tire 1 is filled with air.

The tire 1 rotates having the center axis (Y-axis) as a rotational axis. The Y-axis is the center axis and the rotational axis of the tire 1. An X-axis is an axis that is orthogonal to the Y-axis (the center axis (rotational axis) of the tire 1), and is parallel to a road surface that the tire 1 makes ground contact with. A Z-axis is an axis that is orthogonal to the Y-axis and the X-axis. A direction that is parallel to the Y-axis is a width direction of the tire 1. A direction that passes through the Y-axis and is orthogonal to the Y-axis is a radial direction of the tire 1. Additionally, a circumferential direction centered on the Y-axis is a circumferential direction of the pneumatic tire 1.

As illustrated in FIG. 1, the tire 1 includes a cylindrical annular structure 10, a rubber layer 11, and a carcass portion 12. The annular structure 10 is a cylindrical member. The rubber layer 11 is provided along the circumferential direction of the annular structure 10 on an outer side 10so of the annular structure 10, and constitutes the tread portion of the tire 1. As illustrated in FIG. 3, the carcass portion 12 includes fibers 12F covered by rubber 12R. In this embodiment, as illustrated in FIG. 1, the carcass portion 12 is provided on an inner side in the radial direction of the annular structure 10 and connects both bead portions 13. In other words, the carcass portion 12 is continuous between both of the bead portions 13 and 13. Note that while the carcass portion 12 is provided on both sides in the width direction of the annular structure 10, the carcass portion 12 need not be continuous between both of the bead portions 13 and 13. Thus, as illustrated in FIG. 3, it is sufficient that the carcass portion 12 be provided on both sides in the direction (the width direction) parallel to the center axis (Y-axis) of a cylindrical structure 2 that includes at least the annular structure 10 and the rubber layer 11.

In the tire 1, in a meridian cross-section of the structure 2, an outer side 11so (tread surface of the tire 1) of the rubber layer 11 and the outer side 10so of the annular structure 10, except portions where a groove S is formed in the tread surface, preferably have the same form, and are parallel (including allowance and tolerance).

The annular structure 10 illustrated in FIG. 2-1 is a metal structure. In other words, the annular structure 10 is made from a metal material. The metal material used for the annular structure 10 preferably has a tensile strength of not less than 450 N/m² and not more than 2,500 N/m², more preferably not less than 600 N/m² and not more than 2,400 N/m², and more preferably not less than 800 N/m² and not more than 2,300 N/m². When the tensile strength is within the range described above, sufficient strength and rigidity of the annular structure 10 can be ensured, and necessary toughness can be ensured. As a result, sufficient pressure resistance performance of the annular structure 10 can be ensured.

A pressure resistance parameter is defined as a product of the tensile strength (MPa) and the thickness (mm) of the annular structure 10. The pressure resistance parameter is a parameter by which resistance against internal pressure of the gas that the tire 1 is filled with is measured. The pressure resistance parameter is set to be not less than 200 and not more than 1,700 and preferably not less than 250 and not more than 1,600. When within this range, a maximum usage pressure of the tire 1 can be ensured, and safety can be sufficiently ensured. Additionally, when within the range described above, it is not necessary to increase the thickness of the annular structure 10, and it is also not necessary to use a material with a high breaking strength, which is preferable for mass production. Durability against repeated bending can be ensured for the annular structure 10 because it is not necessary to increase the thickness of the annular structure 10. Additionally, the annular structure 10 and the tire 1 can be manufactured at a low cost because it is not necessary to use a material with a high breaking strength. When used for a passenger car, the pressure resistance parameter is preferably not less than 200 and not more than 1,000, and more preferably not less than 250 and not more than 950. When used as a truck/bus tire (TB tire), the pressure resistance parameter is preferably not less than 500 and not more than 1,700, and more preferably not less than 600 and not more than 1,600.

It is sufficient that the tensile strength of the metal material that can be used for the annular structure 10 be within the range described above, but preferably spring steel, high tensile steel, stainless steel, or titanium (including titanium alloy) is used. Of these, stainless steel has high corrosion resistance and is not prone to oxidation degradation. Additionally, stainless steel is preferable because stainless steel with a tensile strength that is within the range described above is easily obtainable. It is possible to achieve both pressure resistance strength and durability against repeated bending by using stainless steel.

When manufacturing the annular structure 10 from stainless steel, it is preferable to use a JIS (Japanese Industrial Standard) G4303-classified martensitic stainless steel, ferritic stainless steel, austenitic stainless steel, austenitic-ferritic two-phase stainless steel, or precipitation hardening stainless steel. By using such a stainless steel, an annular structure 10 having superior tensile strength and toughness can be obtained. Additionally, of the stainless steels described above, precipitation hardening stainless steel (SUS631 or SUS632J1) is more preferable.

As with an annular structure 10a illustrated in FIG. 2-2, recesses and protrusions 10T having a serrated blade form may be provided on both sides in the width direction of the annular structure 10a. The rubber layer illustrated in FIG. 3 is attached to the outer side in the radial direction of the annular structure 10a, and the recesses and protrusions 10T function to strengthen the bonding between the annular structure 10a and the rubber layer 11. Therefore, providing the annular structure 10a with the recesses and protrusions 10T is preferable because the annular structure 10a and the rubber layer 11 will be more reliably affixed and durability will be enhanced.

The outer side 10so of the annular structure 10 and an inner side 11si of the rubber layer 11 are in contact with each other. In this embodiment, the annular structure 10 and the rubber layer 11 are affixed using, for example, an adhesive. As a result of such a structure, force can be transferred mutually between the annular structure 10 and the rubber layer 11. Methods for affixing the annular structure 10 and the rubber layer 11 are not limited to adhesives. Additionally, the annular structure 10 preferably is not exposed to the outer side in the radial direction of the rubber layer. Such a configuration will lead to the annular structure 10 and the rubber layer 11 being more reliably affixed. Furthermore, the annular structure 10 may be embedded in the rubber layer 11. In such a case as well, the annular structure 10 and the rubber layer 11 can be more reliably bonded.

The rubber layer 11 includes a rubber material including a synthetic rubber, a natural rubber, or a mixture thereof; and carbon, SiO₂ or the like, which is added to the rubber material as a reinforcing material. The rubber layer 11 is an endless belt-like structure. The rubber layer 11 may also have a tread pattern formed from a plurality of grooves on the outer side 11so.

The carcass portion 12 is a strengthening member that, together with the annular structure 10, fulfills a role as a pressure vessel when the tire 1 is filled with air. The carcass portion 12 and the annular structure 10 support the load that acts on the tire 1 due to the internal pressure of the air that fills the interior of the tire 1, and withstand dynamic forces received by the tire 1 during traveling. In this embodiment, an inner liner 14 is provided on an inner side of the carcass portion 12 of the tire 1. The inner liner 14 suppresses the air filling the interior of the tire 1 from leaking. Each end of the carcass portion 12 has a bead portion 13 on the inner side thereof in the radial direction. The bead portions 13 mate with a rim of a wheel on which the tire 1 is attached.

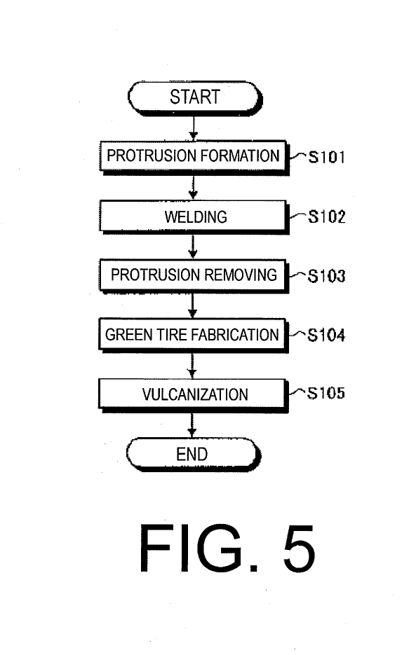

FIG. 4 is a meridian cross-sectional view of the annular structure and the rubber layer. An elastic modulus of the annular structure 10 is preferably not less than 70 GPa and not more than 250 GPa, and more preferably not less than 80 GPa and not more than 230 GPa. Additionally, a thickness tm of the annular structure 10 is preferably not less than 0.1 mm and not more than 0.8 mm. When within this range, durability against repeated bending can be ensured while ensuring pressure resistance performance. A product of the elastic modulus and the thickness tm of the annular structure 10 (referred to as the “rigidity parameter”) is preferably not less than 10 and not more than 500, and more preferably not less than 15 and not more than 400.

By configuring the rigidity parameter to be within the range described above, rigidity of the annular structure 10 in the meridian cross-section increases. As a result, when the tire 1 is filled with air and when the tire 1 makes ground contact with a road surface, deformations caused by the annular structure 10 in the meridian cross-section of the rubber layer 11 (tread portion) are suppressed. Therefore, viscoelastic energy loss of the tire 1 caused by the deformations is suppressed. Additionally, by configuring the rigidity parameter to be within the range described above, rigidity of the annular structure 10 in the radial direction decreases. As a result, the tread portion of the tire 1 pliably deforms at a ground contact portion between the tire 1 and the road surface, just as with conventional pneumatic tires. Due to such a function, the tire 1 eccentrically deforms while localized concentrations of strain and stress in the ground contact portion are avoided and, therefore, strain in the ground contact portion can be dispersed. Therefore, localized deformation of the rubber layer 11 in the ground contact portion is suppressed, resulting in ground contact area of the tire 1 being ensured and rolling resistance being reduced.

Furthermore, with the tire 1, because the in-plane rigidity of the annular structure 10 is great and the ground contact area of the rubber layer 11 is ensured, ground contact length in the circumferential direction can be ensured. Therefore, lateral forces, generated when a rudder angle is input, increase. As a result, the tire 1 can obtain high cornering power. Additionally, when the annular structure 10 is manufactured from a metal, most of the air that the interior of the tire 1 is filled with will not pass through the annular structure 10. This is beneficial as it simplifies managing the air pressure of the tire 1. Therefore, declines in the air pressure of the tire 1 can be suppressed even when usage of the tire 1 is such that the tire 1 is not filled with air for an extended period of time.

A distance tr (thickness of the rubber layer 11) between the outer side 10so of the annular structure 10 and the outer side 11so of the rubber layer 11 is preferably not less than 3 mm and not more than 20 mm. By configuring the distance tr to be within such a range, excessive deformation of the rubber layer 11 when cornering can be suppressed while ensuring riding comfort. The direction parallel to the center axis (Y-axis) of the annular structure 10 or, in other words, a dimension Wm (annular structure width) in the width direction of the annular structure 10 is preferably not less than 50% (W×0.5) and not more than 95% (W×0.95) of the total width (in a state where the tire 1 is assembled on a wheel having a JATMA stipulated rim width and inflated with air to 300 kPa) in the direction parallel to the center axis (Y-axis) of the tire 1 illustrated in FIG. 1. If Wm is less than W×0.5, rigidity in the meridian cross-section of the annular structure 10 will be insufficient, resulting in a reduction of the region that maintains eccentric deformation with respect to the tire width. As a result, the effect of reducing rolling resistance may decline and cornering power may decrease. Moreover, if Wm exceeds W×0.95, the tread portion may cause buckling deformation in the center axis (Y-axis) direction of the annular structure 10 when making ground contact, and this may lead to the deformation of the annular structure 10. By configuring Wm so that W×0.5≦Wm≦W×0.95, cornering power can be maintained while rolling resistance is reduced and, furthermore, deformation of the annular structure 10 can be suppressed.

With the tire 1, in the meridian cross-section illustrated in FIG. 1, the outer side 11so of the rubber layer 11 or, in other words, the profile of the tread surface, except the portions where the groove S is formed, preferably has the same form as the outer side 10so of the annular structure 10. As a result of such a configuration, when the tire 1 makes ground contact or is rolling, the rubber layer 11 (tread portion) and the annular structure 10 deform in substantially the same manner. Therefore, deformation of the rubber layer 11 of the tire 1 is reduced, and this leads to a reduction in viscoelastic energy loss and a further reduction in rolling resistance.

If the outer side 11so of the rubber layer 11 and the outer side 10so of the annular structure 10 protrude facing outward in the radial direction of the tire 1 or, alternately protrude facing inward in the radial direction of the tire 1, pressure distribution in the ground contact portion of the tire 1 will become uneven. As a result, localized concentrations of strain and stress may be generated in the ground contact portion, and localized deformation of the rubber layer 11 may occur in the ground contact portion. In this embodiment, in tire 1, as illustrated in FIG. 3, the outer side 11so of the rubber layer 11 (the tread surface of the tire 1) and the outer side 10so of the annular structure 10 have the same form (preferably parallel) and, furthermore, preferably are parallel (including allowance and tolerance) to the center axis (Y-axis) of the rubber layer 11 and the annular structure 10 (i.e. the structure 2). Due to such a structure, the ground contact portion of the tire 1 can be configured to be substantially flat. With the tire 1, pressure distribution in the ground contact portion is uniform and, therefore, localized concentration of strain and stress in the ground contact portion is suppressed and localized deformation of the rubber layer 11 in the ground contact portion is suppressed. As a result, viscoelastic energy loss is reduced and, therefore, rolling resistance of the tire 1 is also reduced. Additionally, with the tire, localized deformation of the rubber layer 11 in the ground contact portion is suppressed and, therefore, the ground contact area can be ensured and, simultaneously, the ground contact length in the tire circumferential direction can be ensured. Therefore, with the tire 1, cornering power can also be ensured.

In this embodiment, the form of the rubber layer 11 in the meridian cross-section is not particularly limited provided that the outer side 11so of the rubber layer 11 and the outer side 10so of the annular structure 10 are parallel to the center axis (Y-axis). For example, the form of the rubber layer 11 in a meridian cross-section may be a trapezoidal shape or a parallelogram shape. When the form of the rubber layer 11 in the meridian cross-section is trapezoidal, an upper bottom or a lower bottom of the trapezoid may be the outer side 11so of the rubber layer 11. In either case, it is sufficient that only the portion of the annular structure 10 be parallel to the profile (except the portions where the groove is formed) of the tread surface of the tire 1. Next, a method for manufacturing the annular structure will be described.

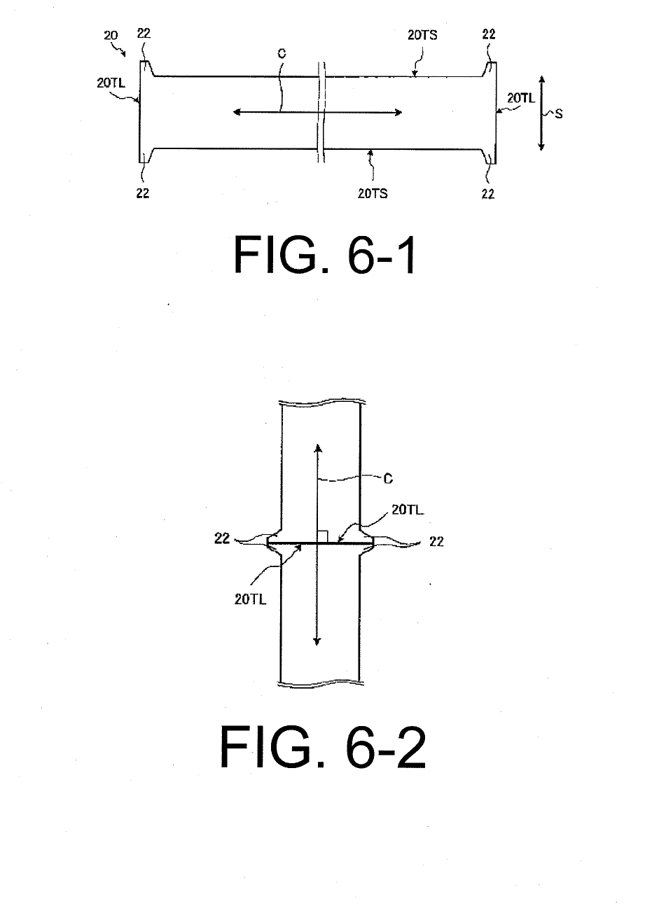

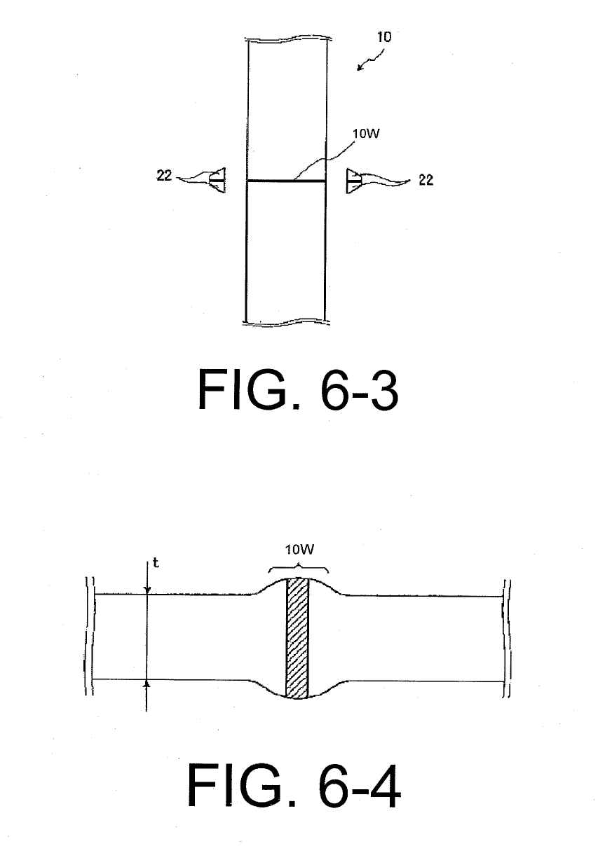

FIG. 5 is a flowchart showing steps of a method for manufacturing the annular structure included in the tire according to the embodiment. FIGS. 6-1 to 6-3 are explanatory drawings illustrating steps of the method for manufacturing the annular structure included in the tire according to the embodiment. FIG. 6-3 is a cross-sectional view illustrating the plate material cut on a plane orthogonal to a plate face of the plate material. FIG. 6-4 is a cross-sectional view illustrating a thickness of a welded portion. When manufacturing the annular structure 10, first, as illustrated in FIG. 6-1, a plate material 20 having a rectangular form when viewed planarly, and having protrusions 22 that protrude outward in a direction parallel to a lateral direction is formed on sides of both edges 20TL and 20TL in the longitudinal direction (the direction indicated by arrow “C” in FIG. 6-1) on both edges 20TS and 20TS in the lateral direction (the direction indicated by arrow “S” in FIG. 6-1) (step S101, FIG. 6-1). When viewed planarly, the edges 20TS and 20TS in the lateral direction correspond to the long sides of the rectangular plate material 20. Also, when viewed planarly, the edges 20TL and 20TL in the longitudinal direction correspond to the short sides of the rectangular plate material 20. The plate material 20 can be obtained by, for example, cutting a large metal plate member.

Next, both edges 20TL and 20TL of the plate material 20 in the longitudinal direction are abutted and joined by welding (step S102, FIG. 6-2). The edges 20TL and 20TL in the longitudinal direction preferably are orthogonal to the longitudinal direction of the plate material 20 (the direction indicated by arrow “C” in FIG. 6-2). With such a configuration, if repeated bending occurs in the welded portion as a result of repeated deformation of the annular structure 10 in the radial direction, declines in the durability of the annular structure 10 can be suppressed because the length of the welded portion where the repeated bending is occurring can be shortened. As a result, when using the annular structure 10 in the tire 1, declines in durability can be suppressed.

Types of welding that can be used include gas welding (oxyacetylene welding), arc welding, TIG (Tungsten Inert Gas) welding, plasma welding, MIG (Metal Inert Gas) welding, electroslag welding, electron beam welding, laser beam welding, ultrasonic welding, and the like. Thus, the annular structure 10 can be easily manufactured by welding both edges of the plate material. Note that following welding, the plate material 20 may be subjected to heat-treating and/or drawing. As a result, the strength of the manufactured annular structure 10 can be increased. For example, when using precipitation hardening stainless steel, an example of the heat-treating is one in which the plate material 20 is heated at 500° C. for 60 minutes. The conditions of the heat-treating are not limited to this though, and can be modified as necessary based on the characteristics sought.

Next, after welding, the protrusions 22 are removed and the annular structure 10 illustrated in FIG. 2-2 is obtained (step S103, FIG. 6-3). Heat-treating and the like of the annular structure 10 is preferably conducted after the protrusions 22 of the joined cylindrical plate material 20 are cut off Because the strength of the welded cylindrical plate material 20 (annular structure 10) will be increased as a result of the heat-treating or the like, the protrusions 22 can be easily cut off by cutting off the protrusions 22 prior to conducting heat-treating or the like. After obtaining the annular structure 10, the rubber layer 11 and the carcass portion 12 illustrated in FIG. 3 are attached to the annular structure 10, and the bead portions 13 are provided in the carcass portion 12. Thus, a green tire is fabricated (step S104). Thereafter, the green tire is vulcanized (step S105) and the tire 1 illustrated in FIG. 1 is completed. Note that the method for manufacturing the annular structure 10 is not limited to the example described above. For example, the annular structure 10 may be manufactured by cutting a cylinder or, alternately, the annular structure 10 may be manufactured via extrusion molding.

The annular structure 10 has a welded portion 10W as illustrated in FIG. 6-3. As illustrated in FIG. 6-4, the welded portion 10W may have a thickness that is greater than a thickness of surroundings thereof. A thickness t at a region of the welded portion 10W, except at the welded portion 10W itself, is not less than 0.1 mm and not more than 0.8 mm, and is preferably not less than 0.15 mm and not more than 0.7 mm. Additionally, the thickness of the portion of the welded portion 10W that is greater than the thickness of the surroundings thereof is not more than 1.3 times, and preferably not more than 1.2 times the thickness of said surroundings. When within this range, durability against repeated bending can be ensured while ensuring pressure resistance performance. The region “except at the welded portion 10W itself” refers to the thickness of the plate material 20 prior to welding and, in the annular structure 10, refers to the regions other than the welded portion 10W that have a uniform thickness.

In this embodiment, after joining the plate material by welding, preferably the welded cylindrical plate material 20 is subjected to heat-treating and/or the welded cylindrical plate material 20 is subjected to drawing in an axial direction of the cylinder. As a result of such treatment, the material characteristics of the welded portion (metallographic structure) that has been altered by the welding can be adjusted to be similar to those of the non-welded portion and, therefore, breaking strength at the welded portion is increased. Note that, when performing the treatments described above, a plurality of the annular structure 10 can be simultaneously manufactured by: fabricating a long, cylindrical material by welding a plate material having a large width direction dimension; subjecting the obtained cylinder to the treatments described above; and, thereafter, cutting the cylinder perpendicular to an axis thereof at the annular structure width Wm (belt width).

As described above, the pneumatic tire according to this embodiment has an annular structure with a rigidity parameter (defined as the product of the elastic modulus and the thickness) that is not less than 10 and not more than 500, and a rubber layer disposed on the outer side of the annular structure. Due to such a structure, the tire of this embodiment eccentrically deforms while localized concentrations of strain and stress of the rubber layer in the ground contact portion are avoided and, therefore, strain in the ground contact portion can be dispersed. As a result, with the tire of this embodiment, localized deformation of the rubber layer in the ground contact portion is suppressed and, therefore, concentrations of strain and stress in the ground contact portion are dispersed and rolling resistance is reduced. Thus, with this embodiment, a structure whereby the rolling resistance of a pneumatic tire is reduced can be provided. Moreover, by using an annular structure having a tensile strength of not less than 450 N/m² and not more than 2,500 N/m², sufficient strength and rigidity of the annular structure can be ensured, and necessary toughness can be ensured. As a result, sufficient pressure resistance performance of the annular structure can be ensured.

Additionally, as a result of the structure described above, with the pneumatic tire according to this embodiment, when the rubber layer becomes worn, the rubber layer can be removed from the annular structure and a new rubber layer can be attached to the annular structure. Thus, retreading is facilitated. With the pneumatic tire according to this embodiment, provided that defects are not produced, the carcass and the annular structure can be used multiple times. As a result, waste components are reduced and environmental impact is lightened. Furthermore, with the pneumatic tire according to this embodiment, the annular structure is formed by forming a plate-like member into a cylindrical form, and the annular structure is disposed so as to surround the space filled with air. As a result, with the pneumatic tire according to this embodiment, the annular structure prevents the intrusion of foreign objects from the road contact surface (outer side of the rubber layer) into the space filled with air. Therefore, the pneumatic tire according to this embodiment has a benefit of not being prone to punctures.

What is claimed is:

1. A pneumatic tire comprising:
an annular structure that is a cylindrical and metal structure, having a tensile strength not less than 450 N/m² and not more than 2500 N/m²;
a rubber layer that will become a tread portion provided along a circumferential direction of the annular structure on an outer side of the annular structure; and
a carcass portion including fibers covered by rubber, provided on at least both sides in a direction parallel to a center axis of the cylindrical structure including the annular structure and the rubber layer.

2. The pneumatic tire according to claim 1, wherein in a meridian cross-section of the structure, an outer side of the rubber layer and the outer side of the annular structure have the same form.

3. The pneumatic tire according to claim 1, wherein the annular structure is formed by abutting edges of band-like steel plates and welding.

4. The pneumatic tire according to claim 3, wherein:
a thickness at a region of the annular structure, except a welded portion, is not less than 0.1 mm and not more than 0.8 mm; and
a thickness of a portion of the welded portion that is greater than the thickness of surroundings of the welded portion is not more than 1.3 times the thickness of the surroundings.

5. The pneumatic tire according to claim 3, wherein the annular structure is obtained by joining edges of both sides in a longitudinal direction of a plate material by welding, the plate material having a substantially rectangular form when viewed planarly, and having protrusions that protrude outward in a direction parallel to a lateral direction on sides of both edges in the longitudinal direction on both edges in the lateral direction; and, thereafter, removing the protrusions.

6. The pneumatic tire according to claim 1, wherein the annular structure is a metal.

7. The pneumatic tire according to claim 6, wherein the annular structure is stainless steel.

8. The pneumatic tire according to claim 1, wherein an outer side of the rubber layer and the outer side of the annular structure, except a groove portion of the rubber layer, are parallel to the center axis.

9. The pneumatic tire according to claim 1, wherein the annular structure is disposed farther outward in a radial direction of the structure than the carcass portion.

10. The pneumatic tire according to claim 1, wherein a dimension in the direction parallel to the center axis of the annular structure is not less than 50% and not more than 95% of a total width in the direction parallel to the center axis of the pneumatic tire.

11. The pneumatic tire according to claim 1, wherein a distance between the outer side of the annular structure and an outer side of the rubber layer is not less than 3 mm and not more than 20 mm.

12. The pneumatic tire according to claim 1, wherein the tensile strength is not less than 800 N/m² and not more than 2,300 N/m².

13. The pneumatic tire according to claim 1, wherein a pressure resistance parameter of the annular structure, defined as a product of the tensile strength and a thickness of the annular structure, is set to be not less than 200 and not more than 1,700.

14. The pneumatic tire according to claim 13, wherein the pneumatic tire is a passenger car tire and the pressure resistance parameter is not less than 250 and not more than 950.

15. The pneumatic tire according to claim 13, wherein the pneumatic tire is a truck or bus tire and the pressure resistance parameter is not less than 600 and not more than 1,600.

16. The pneumatic tire according to claim 1, wherein the annular structure is a stainless steel selected from the group consisting of: a martensitic stainless steel, ferritic stainless steel, austenitic stainless steel, austenitic-ferritic two-phase stainless steel, and precipitation hardening stainless steel.

17. The pneumatic tire according to claim 1, wherein an elastic modulus of the annular structure is not less than 80 GPa and not more than 230 GPa, a thickness of the annular structure is not less than 0.1 mm and not more than 0.8 mm, and a product of the elastic modulus and the thickness of the annular structure is not less than 15 and not more than 400.

18. The pneumatic tire according to claim 1, wherein a tire width W and an annular structure width are configured such that W×0.5≦Wm≦W×0.95.

19. A method of manufacturing a pneumatic tire, the pneumatic tire comprising a rubber layer that will become a tread portion, provided on an outer side of a cylindrical and metal annular structure, the method comprising the steps of:
obtaining a plate material having a substantially rectangular form when viewed planarly, and having protrusions that protrude outward in a direction parallel to a lateral direction on sides of both edges in a longitudinal direction on both edges in the lateral direction;
joining both edges in the longitudinal direction of the plate material by welding; and
removing the protrusions, thereby obtaining the annular structure.

20. The method of manufacturing a pneumatic tire according to claim 19, wherein after joining the plate material by welding, the joined cylindrical plate material is subjected to heat-treating and/or the joined cylindrical plate material is subjected to drawing in an axial direction.
